(19) United States
(12) Patent Application Publication
(10) Pub. No.: US 2022/0415121 A1
(43) Pub. Date: Dec. 29, 2022

(54) Systems, Methods, Apparatuses, And Computer-Readable Storage Media For Warning

(71) Applicant: SENSETIME INTERNATIONAL PTE. LTD., Singapore (SG)

(72) Inventors: Xinxin Wang, Singapore (SG); Jinliang Lin, Singapore (SG); Chuan Zou, Singapore (SG); Jiacheng Wu, Singapore (SG)

(21) Appl. No.: 17/364,316

(22) Filed: Jun. 30, 2021

Related U.S. Application Data
(63) Continuation of application No. PCT/IB2021/055747, filed on Jun. 28, 2021.

(30) Foreign Application Priority Data
Jun. 24, 2021 (SG) 10202106953P

(51) Int. Cl. G07F 17/32; G06K 9/00; G08B 25/00; G08B 5/36

(52) U.S. Cl. CPC G07F 17/3241; G07F 17/3232; G06K 9/00771; G08B 25/001; G08B 5/36

(57) ABSTRACT

This application provides a system, a method, an apparatus, and a computer-readable storage medium for warning. The system may include an image capture device deployed on a gaming site and configured to capture a live image of a game table on the gaming site; and a computing node deployed on the gaming site and being connected to the image capture device, wherein the computing node is configured to obtain, in response to a receipt of the live image sent by the image capture device, a detection result characterizing a gaming process by performing a detection on the live image; and report, in response to that the obtained detection result matches a first preset warning condition, first warning information corresponding to the first preset warning condition.

### CROSS REFERENCE TO RELATED APPLICATION

This application is a continuation of International Application No. PCT/IB2021/055747 filed on Jun. 28, 2021, which claims priority to Singaporean Patent Application No. 10202106953P entitled “SYSTEMS, METHODS, APPARATUSES, AND COMPUTER-READABLE STORAGE MEDIA FOR WARNING” and filed on Jun. 24, 2021, which is incorporated herein by reference in its entirety.

### TECHNICAL FIELD

This application relates to computer technologies, and specifically, to a system, a method, an apparatus, and a computer-readable storage medium for warning.

### BACKGROUND

Game participants usually are expected to play a game according to a game rule. During a game, if a game participant does not play the game according to the game rule, a warning needs to be issued. For example, in a card game, a card dealing order needs to follow a specific game rule. If the card dealing order is incorrect, a warning needs to be issued. At present, the process of a game is mainly controlled by an on-site person, and excessive reliance on the on-site person may cause problems such as an untimely warning, a missed warning, and cheating.

### SUMMARY

In view of this, this application discloses at least a warning system. The system may include an image capture device deployed on a gaming site and configured to capture a live image of a game table on the gaming site and a computing node deployed on the gaming site, and being connected to the image capture device, where the computing node is configured to: obtain, in response to a receipt of a live image sent by the image capture device, a detection result characterizing a gaming process by performing a detection on the live image; and report, in response to that the obtained detection result matches a first preset warning condition, first warning information corresponding to the first preset warning condition.

In some embodiments, the system further includes: a first interaction terminal connected to the computing node, where the first interaction terminal is configured to interact with a first user controlling the gaming process on the game table; the computing node is configured to send the first warning information to the first interaction terminal in response to that the obtained detection result matches the first preset warning condition; and the first interaction terminal is configured to report the first warning information to the first user in response to a receipt of the first warning information.

In some embodiments, the system further includes: a first server and a second server that are connected to the first interaction terminal and a second interaction terminal connected to the second server, where the second interaction terminal is configured to interact with a second user managing one or more gaming site on the gaming site; the first interaction terminal is configured to send the first warning information to the first server and the second server; the first server is configured to store the first warning information in response to a receipt of the first warning information; the second server is configured to send the first warning information to the second interaction terminal in response to a receipt of the first warning information; and the second interaction terminal is configured to report the first warning information to the second user.

In some embodiments, a plurality of the second interaction terminals and a plurality of the game tables are provided in the gaming site, each of the game tables is provided with a group of the image capture devices, the computing node, and the first interaction terminal.

In some embodiments, the first interaction terminal is configured to: detect a user operation of the first user, and report second warning information in response to detecting that the operation of the first user is abnormal or to request authorization.

In some embodiments, the computing node is configured to: detect a working status of the image capture device, and report third warning information in response to detecting that the working status of the image capture device matches a second preset warning condition.

In some embodiments, the system further includes: a third server connected to the computing node, and configured to: acquire at least one of a working status and an event of the image capture device and the computing node by using a federation mechanism, and report fourth warning information in response to that at least one of the working status and the event of the image capture device or the computing node matches the second preset warning condition.

In some embodiments, the third server is configured to: in response to that at least one of the working status and the event of the image capture device or the computing node matches the second preset warning condition, send a warning email by an email system, and send the fourth warning information to the second server which is connected to the third server; and the second server is configured to: send the fourth warning information to the second interaction terminal connected to the second server.

In some embodiments, where for each piece of warning information including the first warning information, the second warning information, the third warning information, and the fourth warning information; the system maintains a preset warning condition matching warning information and warning levels corresponding to the preset warning conditions; and at least of the first interaction terminal and the second interaction terminal is configured to: determine a warning level of warning information based on the preset warning condition matching the warning information, and report the warning information in a feedback manner corresponding to the determined warning level.

In some embodiments, at least one of the first interaction terminal and the second interaction terminal includes a color indicator light corresponding to the warning level; and at least one of the first interaction terminal and the second interaction terminal is configured to: issue the warning information by the color indicator light corresponding to the warning level.

In some embodiments, at least one of the first interaction terminal and the second interaction terminal is configured to: clear the warning information in response to a clearing operation for the warning information; and in response to that clearing operation for the warning information is not received within a preset duration, upgrade the warning level corresponding to the warning information, and send a notification to at least one of the first server and the second server, so to cause at least one of that the first server sends the notification to the first interaction terminal and the second server sends the notification to the second interaction terminal.

In some embodiments, at least one of the first interaction terminal and the second interaction terminal is configured to: clear the warning information in response to that a clearing operation for the warning information with upgraded warning level is received.

In some embodiments, the computing node is further configured to: in response to determining that a warning event of the game table has been canceled; issue information of cancelling warning.

This application further provides a warning method, applicable to a computing node, the method including: acquiring a live image captured by an image capture device deployed on a gaming site; obtaining a detection result characterizing a gaming process by performing a detection on the live image; and comparing the detection result with a first preset warning condition, and issuing warning information corresponding to the first preset warning condition in response to that the detection result matches the first preset warning condition.

This application further provides an apparatus for warning, applicable to a computing node, the apparatus including: an acquisition module, configured to acquire a live image captured by an image capture device deployed on a gaming site; a detection module, configured to obtain a detection result characterizing a game process by performing a detection on the live image; and a first warning module, configured to: compare the detection result with a first preset warning condition, and issue warning information corresponding to the first preset warning condition in response to that the detection result matches the first preset warning condition.

This application further provides a computer-readable storage medium. The storage medium stores a computer program. The computer program is configured to cause a processor to perform the method of warning according to any one of the foregoing embodiments.

In the foregoing solutions, by capturing a live image with an image capture device deployed on a gaming site and performing a detection on the live image with a computing node deployed on the gaming site, warning information may be reported to a user in response to that a detection result matches a first preset warning condition. Therefore, the process of a game can be monitored actively and thus a warning of an abnormal situation can be issued in time.

It is to be understood that, the foregoing general descriptions and the following detailed descriptions are merely for illustration and explanation purposes and are not intended to limit this application.

### BRIEF DESCRIPTION OF THE DRAWINGS

To describe the technical solutions of one or more embodiments of this application or the related art more clearly, the following briefly introduces the accompanying drawings required for describing the embodiments or the related art. The accompanying drawings in the following description show merely some embodiments of one or more of this application, and a person of ordinary skill in the art may still derive other drawings from these accompanying drawings without creative efforts.

FIG. 1 is a schematic structural diagram of a system of warning according to this application;

FIG. 2 is a schematic structural diagram of a system of warning according to this application;

FIG. 3 is a schematic structural diagram of a system of warning according to this application;

FIG. 4 is a schematic structural diagram of a system of warning according to this application;

FIG. 5 is a method flowchart of a method of warning according to this application; and

FIG. 6 is a schematic structural diagram of an apparatus for warning according to this application.

### DETAILED DESCRIPTION OF THE EMBODIMENTS

Exemplary embodiments are described in detail below, and examples of the exemplary embodiments are shown in the accompanying drawings. When the following description involves the accompanying drawings, unless otherwise indicated, the same numerals in different accompanying drawings represent the same or similar elements. The implementations described in the following exemplary embodiments do not represent all implementations that are consistent with this application. On the contrary, the implementations are merely examples of devices and methods that are described in detail in the appended claims and that are consistent with some aspects of this application.

The terms used in this application are for the purpose of describing specific embodiments only and are not intended to limit this application. The singular forms of “a” and “the” used in this application and the appended claims are intended to include the plural forms as well, unless the context clearly indicates otherwise. It should be further understood that the term “and/or” used herein indicates and includes any or all possible combinations of one or more associated listed items. It should be further understood that depending on the context, the word “if” used in the specification can be interpreted as “when”, “as”, or “in response to determining”.

Based thereupon, this application provides a warning system (which is referred to as a system below). In the system, a live image may be captured by using an image capture device deployed on a gaming site, and the live image is detected by using a computing node deployed on the gaming site. Warning information is reported to a user in response to that a detection result matches a first preset warning condition. Therefore, a game process can be automatically monitored, and a warning of an abnormal situation can be issued in time.

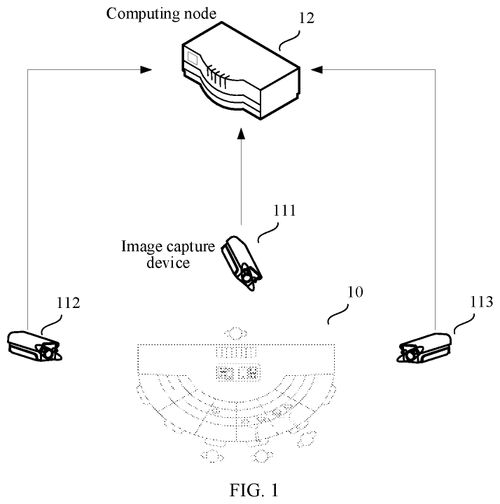

FIG. 1 is a schematic structural diagram of a warning system according to this application.

As shown in FIG. 1, the system may include image capture devices 111 to 113 and a computing node 12 that are deployed on a gaming site. The computing node 12 is connected to the image capture devices 111 to 113.

The image capture devices may be configured to: capture live images of a game table on the gaming site, and send the live images to the computing node.

The computing node is configured to: obtain, in response to a receipt of the live images sent by the image capture devices, a detection result characterizing a game process by performing a detection on the live image; and report, in response to that the obtained detection result matches a first preset warning condition, first warning information corresponding to the first preset warning condition.

The gaming site 10 shown in FIG. 1 may be a gaming site of any game, for example, may be a table gaming site. To capture an image on the gaming site, several image capture devices may be deployed on the gaming site.

The image capture devices may be devices of any type such as image capture modules, video cameras, or cameras, configured to capture the live images of the game table on the gaming site. In some embodiments, image capture devices in a plurality angles may be deployed on the gaming site, and a complete gaming site image set is captured in a region-based image capture manner or an object-based image capture manner. For example, in the scenario shown in FIG. 1, the image capture devices 111 to 113 may be respectively set directly above the game table, on the upper left of the game table, and on the upper right of the game table. Each camera may capture a live image of one region of the gaming site, so that the computing node may issue warnings based on live images respectively captured by the three cameras. In some embodiments, exposure and frame taking of a plurality of cameras deployed on a site may be triggered at the same time in a hard trigger (square wave trigger) manner or a soft trigger (signal trigger) manner, to ensure synchronization of game process detections.

The live images may involve some game information related to the game process. Game information in the live images may be obtained by performing a detection on the live images. Warning determining may be performed by detecting the game information.

For example, in a card game, a card player in a current turn may be parsed by using a plurality of consecutive frames of images. If the parsed card player is inconsistent with a card player in the current turn, a warning of an abnormal order may be issued. In another example, face value information of card objects appearing in live images may be used to determine a game winner of a current game. If the determined game winner is inconsistent with a game winner determined on the gaming site, a warning of an abnormal game result may be issued.

After capturing the live images, the image capture devices may send the live images to the computing node.

The computing node (which is briefly referred to as a node below) may be an electronic device of any type such as a notebook computer, a computer, a server, a mobile phone, a PAD terminal, or an industrial computer. A type of the electronic device is not particularly limited in this application. The computing node may be connected to the image capture devices in a wired or wireless manner. In some embodiments, to ensure data transmission efficiency, bandwidth, and stability, the computing node may be connected to the image capture devices through a gigabit network port. The computing node may be deployed on the gaming site, and process, as an edge node, in real time the live images captured by the image capture devices.

The computing node may include a plurality of logic layers to implement warning logic. In some embodiments, the computing node may include an algorithm layer, a software layer, a platform layer, and a service layer. The algorithm layer may include algorithm logic such as a target detection algorithm, a target tracking algorithm, an object orientation algorithm, and an object face value algorithm for basic operations. The software layer may be used to perform a detection on a live image based on an algorithm provided by the algorithm layer, comparing a detection result with preset warning conditions, and the like, to implement warning detection. The platform layer is used to detect a working status of each device and to warn an abnormal working status. The service layer may be used to send warning information to another device connected to the node in response to a warning request sent by the platform layer or the software layer. In some embodiments, because the computing node can perform an artificial intelligence operation, the computing node can also be referred to as an artificial intelligence node.

Data communication may be performed between the plurality of logic layers included in the computing node. In some embodiments, communication of a message between the logical layers may be performed by using a message mechanism (RocketMQ).

In some embodiments, the service layer can communicate with another device in a websocket (instant messaging) manner to improve communication efficiency.

A first preset warning condition may be preset in the computing node. The first preset warning condition is a warning condition related to an on-site game rule. For example, the first preset warning condition may be conditions for appearance of abnormal situations such as an abnormal order of turn, abnormal game result determining, abnormal game coin exchange, abnormal game coin placement, an abnormal order of looking at card, and an abnormal card dealing order. These first preset warning conditions may be converted into codes for storage into the node.

After receiving the live images, the computing node may obtain, by running an algorithm deployed on the computing node, a detection result characterizing a gaming process by performing a detection on the live images.

For example, in a card game, a card object newly distributed (that is, newly appearing in a live image) in a live image may be detected by using the target detection algorithm and the target tracking algorithm. Then, a card receiver corresponding to the current game process represented by the live image may be determined based on a game participant to which a region in which the card object is located belongs. Subsequently, the detected card object receiver may be used to match a maintained card object receiver to which the current game process should correspond. If the detected card object receiver matches the maintained card object receiver, it is determined that the detection result is that a distributed order of the card object is correct; or otherwise, it is determined that the detection result is that a distributed order is abnormal.

After the detection result is obtained, the detection result may be used to match the maintained first preset warning conditions. If the detection result successfully matches any first preset warning condition, a warning may be issued. In some embodiments, the computing node may present the first warning information to gaming site management personnel by using an SMS message, an email, or the like, so that the site management personnel perform corresponding processing.

The first warning information may include prompt content related to abnormality in a game process. For example, the prompt content may include a description about an abnormal situation, a moment at which the abnormality occurs, a person in charge, information about a device discovering the abnormality, and a game table number corresponding to the abnormality.

In the foregoing solution, the image capture devices may send the captured live images of the game table to the computing node. In response to that the detection result, which characterizes a gaming process and is obtained by performing a detection on the live images, matches a first preset warning condition, the computing node report warning information. In this way, the process of a game can be monitored actively, and thus a warning of an abnormal situation can be issued in time.

In some embodiments, the gaming site may include a plurality of regions. A table game is used as an example. The gaming site may include a plurality of game tables. In some embodiments, the game process may be detected by a centralized computing node. For example, an image capture device may be deployed for each of the game tables. Each of image capture devices may access the centralized computing node, and the centralized computing node detects the game process and issues a warning. In this way, detection for the plurality of game tables can be implemented. Alternatively, a group of image capture devices and one computing node may be correspondingly deployed for each of the game tables. In this way, a game process can be analyzed and a warning can be issued for each of the game tables by using an independent computing node, thereby improving real-time performance.

In some embodiments, the gaming site includes: a plurality of second interaction terminals, a plurality of game tables, a plurality of groups of image capture devices which respectively corresponds to the plurality of game tables, a plurality of computing nodes which respectively corresponds to the plurality of groups of image capture devices, and a plurality of first interaction terminals respectively connected to the plurality of computing nodes; each of the plurality of first interaction terminals is connected to a first server and a second server; and each of the plurality of second interaction terminals is connected to the second server. Each group of the plurality of groups image capture devices may include at least one image capture device. Installation positions of image capture devices in a same group may be different from each other.

Therefore, each computing node merely receives live images captured by a group of the image capture devices deployed corresponding to the game table, thereby helping reduce an impact of a breakdown of a central node on a warning system, and helping reduce reliance of image data transmission on large bandwidth. In this way, system costs are reduced, and stability and reliability of the system are improved.

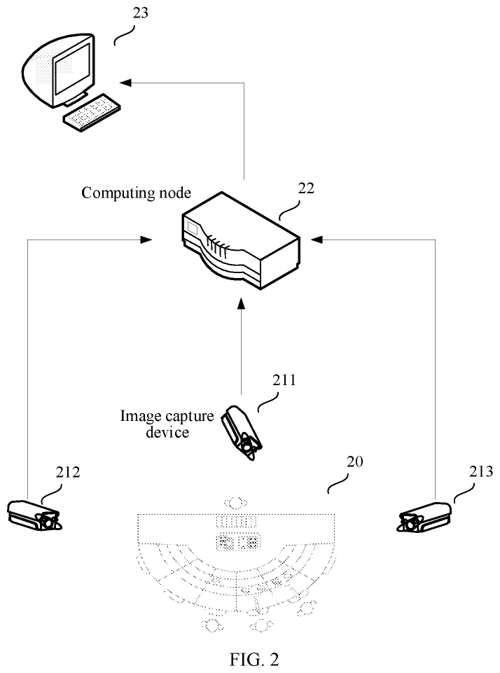

FIG. 2 is a schematic structural diagram of a warning system according to this application.

As shown in FIG. 2, the system may include image capture devices 211 to 213 and a computing node 22 that are deployed on a gaming site, and a first interaction terminal 23 connected to the computing node. The computing node 22 is connected to the image capture devices 211 to 213.

The first interaction terminal is configured to interact with a first user. The first user may include a person controlling the gaming process on the game table. For example, in a table game, the first user may be a game master, for example, a dealer in a card game. In some embodiments, the first interaction terminal may be deployed around the first user on the gaming site 20, so that the first user interacts with the terminal.

The first interaction terminal may be an electronic device of any type such as a notebook computer, a computer, a server, a mobile phone, a PAD terminal, or an industrial computer. The terminal may interact with the first user by using an interactive component (for example, a touchscreen).

In the scenario shown in FIG. 2, the computing node is configured to send first warning information to the first interaction terminal in response to that an obtained detection result matches a first preset warning condition; and the first interaction terminal is configured to report the first warning information to the first user in response to a receipt of the first warning information. In this way, the first user can learn of a game abnormality in time.

In some embodiments, the computing node may be connected to the first interaction terminal in a wired manner (for example, by using a serial bus, a USB, or a network cable). The node may be connected to the first interaction terminal through a websocket, and then, send the first warning information to the terminal. After receiving the warning information, the terminal may present the first warning information to the first user by using the interactive component. In this way, the warning information may be reported to the first user, so that the first user can learn of a situation on the site. In some cases, the first interaction terminal may be a device deployed on the site before the warning system disclosed in this application is implemented. In this example, the computing node may send warning information to the first interaction terminal for communication, so that the warning system can be compatible with a device deployed on the site, thereby improving compatibility of the warning system.

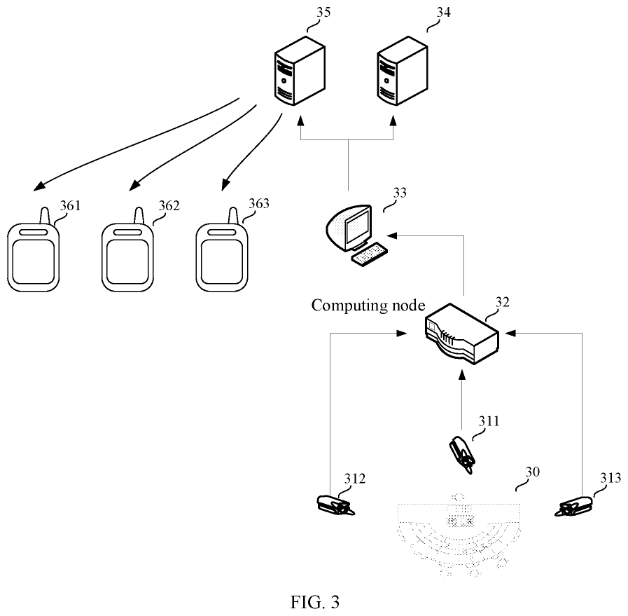

FIG. 3 is a schematic structural diagram of a warning system according to this application.

As shown in FIG. 3, the system may include image capture devices 311 to 313 and a computing node 32 that are deployed on a gaming site, a first interaction terminal 33 connected to the computing node, a first server 34 and a second server 35 that are connected to the first interaction terminal 33, and second interaction terminals 361 to 363 connected to the second server 35. The computing node 32 is connected to the image capture devices 311 to 313.

The first server 34 may be configured to provide a service such as data storage for the first interaction terminal. The first server may be a server that comprehensively manages the gaming site.

The second server 35 may be a candidate server of the second interaction terminals, and is configured to provide a service such as data storage for the second interaction terminals. The second interaction terminals are configured to interact with a second user. The second user may include a management personnel of the gaming site 30. Such personnel may not directly participate in a game, but manage game masters of a plurality of game tables on the gaming site. In some embodiments, the second user may be a duty manager on the gaming site. In some embodiments, the second interaction terminals may be deployed around the second user on the gaming site 30, so that the second user interacts with the terminals.

The first server and the second server may be single servers, server clusters, or cloud servers.

The second interaction terminals may be electronic devices of any type such as notebook computers, computers, servers, mobile phones, PAD terminals, or industrial computers. The terminals may interact with the second user by using an interactive component (for example, a touchscreen). In some embodiments, to improve the portability of the terminals, the second interaction terminals may be handheld terminals, thereby adapting to characteristics that the second user needs to move flexibly.

In the scenario shown in FIG. 3, the first interaction terminal is configured to send a first warning information to the first server and the second server; the first server is configured to store the first warning information in response to a receipt of the first warning information; the second server is configured to send the first warning information to the second interaction terminals in response to a receipt of the first warning information; and the second interaction terminals are configured to report the first warning information to the second user.

In some embodiments, the first server and the second server may be connected to a plurality of computing nodes on the gaming site, and process warning events of a plurality of game tables at the same time.

In some embodiments, a server and a terminal may perform data communication by using a hypertext transfer protocol (HTTP) or the like. A communication manner is not particularly limited in this application. As such, warning information can be summarized to the first server for subsequent review. Furthermore, the warning information may be transferred to the second user, so that the second user can learn of a situation on the site.

In some cases, the second interaction terminals may be devices deployed on the site before the warning system disclosed in this application is implemented. In this example, the first interaction terminal sends the warning information to the second server for communication; and then, the second server sends the warning information to the second interaction terminals, so that the warning system can be compatible with a device deployed on the site, thereby improving the compatibility of the warning system.

In some embodiments, the gaming site may include a plurality of game tables and a plurality of second users. Each of the second users is responsible for managing several game tables, and each of the second users holds a corresponding second interaction terminal. A correspondence between a game table and a second interaction terminal is maintained in the second server. After receiving warning information, the second server may determine a corresponding second interaction terminal by using game table information included in the warning information; and then, may send the warning information to the corresponding second interaction terminal, so that the second user managing the game table receives the information, thereby implementing accurate sending of the warning information.

In some embodiments, a working status of a device in the warning system may further be detected, and a warning is issued when the working status of the device is abnormal, thereby implementing status detection on the device.

The computing node may be configured to: detect working statuses of the image capture devices connected to the computing node, and report third warning information in response to that the working statuses of the image capture devices match a second preset warning condition.

The image capture devices may periodically send working status report information such as heartbeat packets to the computing node. If the computing node periodically receives the heartbeat packets sent by the image capture devices, the computing node may determine that the working statuses of the devices are normal; or otherwise, determine that the working statuses of the devices are abnormal. In some embodiments, after determining the working statuses of the image capture devices, the computing node may maintain the working statuses corresponding to the image capture devices.

The computing node may prestore the second preset warning condition. The second preset warning condition is a warning condition related to device operation and maintenance. For example, the second preset warning condition may be an abnormal connection of an image capture device, an abnormal working status of an image capture device, and abnormal periodic detection on an image capture device. These second preset warning conditions may be converted into codes for storage into the node.

The third warning information may prompt the prompt content related to device operation and maintenance. For example, the third warning information may include information such as a serial number of a device that has an abnormal connection or a serial number of a device that needs to be maintained, so that which device needs to be maintained can be prompted.

In some embodiments, a Prometheus solution may be used at a platform layer included in the computing node. In the Prometheus solution, the working status of each image capture device may be periodically polled. In the Prometheus solution, if it is determined that the working status of the image capture device matches any second preset warning condition, a service layer may be notified, so that the service layer issues a warning. In this way, the working status of the device in the warning system can be warned of, thereby improving the reliability of the warning system.

In some embodiments, the warning system further includes a third server connected to the computing node, and the third server is configured to detect a status of the computing node. In some embodiments, the third server may be equipped with a computing node management system to detect a working status and a connection status of each computing node.

The third server may be configured to: acquire working statuses and/or events of the image capture devices and the computing node by using a federation mechanism, and report fourth warning information in response to that the working statuses and/or the events of the image capture devices or the computing node match the second preset warning condition. In this way, the working status of each device (including the computing node) in the warning system can be detected and warned of, thereby improving the reliability of the warning system.

In some embodiments, the third server may be implemented as a serving module in the first server or the second server.

The fourth warning information is used for prompting the prompt content related to device operation and maintenance. Compared with the third warning information, in addition to operation and maintenance statuses of the image capture devices, the fourth warning information may further prompt an operation and maintenance status of each node device.

In some embodiments, because an abnormal working status of a device may result in system paralysis, the abnormality needs to be processed in time. To warn of such abnormalities in time, the third server may be configured to: in response to that the working statuses and/or the events of the image capture devices or the computing node match the second preset warning condition, send a warning email by an email system, and send the fourth warning information to the second server which is connected to the third server; and the second server is configured to: send the fourth warning information to the second interaction terminals connected to the second server. In this way, an abnormality can be warned of in time by combining an email notification and a warning information transfer manner, thereby improving the timeliness of abnormality processing.

In some embodiments, the warning system may further perform a detection on a user operation, and send a warning if detect that an abnormal operation beyond permission or to request authorization.

The first interaction terminal is configured to: detect and receive a user operation of the first user, and report second warning information in response to detecting that the operation of the first user is abnormal operation or to request authorization.

The second warning information may prompt information related to an authorization. For example, the second warning information may include an unauthorized operation of a user or content of a request of a user for an operating authorization.

The first interaction terminal may be equipped with a client device corresponding to the warning system, and the first user may perform an operation by using the client device after logging in to an account. An operating authorization to the client device is granted to each of first users in advance. If any user performs an operation beyond the authorization granted to the user, the first interaction terminal may issue a warning. In some embodiments, the first user may initiate an authorization request to an administrator. After receiving the authorization request, the first interaction terminal may generate warning information and transfer the warning information to the second user (the administrator). The second user may log in to an account of the second user in the second interaction terminals or the first interaction terminal to complete authorization or prohibit authorization. In this way, the user operation can be detected, and the abnormal operation and the authorization request can be warned of, thereby improving the practicability of the warning system.

In some embodiments, warning information may be reported in a feedback manner corresponding to a warning level, so that a user can learn of a warning importance in time based on different feedback manners, and deal with the warning based on an actual situation. It may be understood that the warning information may include the first warning information, the second warning information, the third warning information, and the fourth warning information.

The first interaction terminal and/or the second interaction terminals are configured to: determine a warning level of the warning information based on the preset warning conditions matching the warning information, and report the warning information in a feedback manner corresponding to the determined warning level.

The system maintains the preset warning conditions matching the warning information. In a case that a detection result of a game process, an operation and maintenance status of a device, or a user operation matches any maintained preset warning condition, a warning may be issued. The preset warning conditions may include the first preset warning condition, the second preset warning condition, and the like. The preset warning conditions correspond to warning levels. In some embodiments, when setting preset warning conditions, warning levels may respectively be specified for the corresponding preset warning conditions.

Each level of the warning levels may represent importance or urgency of the warning information. In some embodiments, a higher warning level indicates a higher importance.

In some embodiments, the warning system (for example, the first interaction terminal and/or the second interaction terminals) may prestore a first correspondence between a preset warning condition and a warning level and a second correspondence between a warning level and a feedback manner. After receiving warning information, a terminal may determine a warning level of the warning information based on the maintained first correspondence; and then, determine a corresponding feedback manner based on the second correspondence and the warning level, and report the warning information in the determined feedback manner. In this way, a user can learn of a warning importance in time based on different feedback manners, and deal with the warning based on an actual situation. For example, when learning that a warning level of warning information is low, the user may deal with another more urgent matter in priority.

In some embodiments, warning information of different warning levels may be prompted by using different color indicator lights, so that a user intuitively learns of importance of the warning information, and deal with the warning based on an actual situation.

The first interaction terminal and/or the second interaction terminals include a color indicator light corresponding to the warning level.

The first interaction terminal and/or the second interaction terminals may be configured to issue the warning information by using the color indicator light corresponding to the warning level.

For example, it is assumed that there are warning levels: levels 1 to 3. Level 1 corresponds to blue light, level 2 corresponds to red light, and level 3 corresponds to white light. After receiving warning information, a terminal may determine an indicator light of a corresponding color based on a warning level, and present the determined indicator light to a user, so that the user can intuitively lean of importance of the warning information based on the color of the lighting light, and deal with the warning based on an actual situation.

In some embodiments, a warning may be cancelled in response to a warning situation. The first interaction terminal and/or the second interaction terminals may be configured to clear the warning information in response to a clearing operation for the warning information.

The clearing operation may include operations such as touching a cancel button, voice control, a fingerprint, and face recognition.

In some embodiments, warning cancelling may include active warning cancelling and passive warning cancelling. In an active warning cancelling situation, the computing node may be configured to: in response to determining that a warning event of the game table has been canceled according to the detection result after sending the first warning information, issue information of cancelling warning.

For example, when a node detects, based on a captured live image, that a warning has been canceled, in other words, the first or the second preset warning condition is not satisfied, the node may transfer a request of clearing the warning information, and the first interaction terminal and/or the second interaction terminals may cancel the warning in response to the information.

In a passive warning cancelling situation, a user may perform, for the warning information, a cancelling warning operation such as touching a dismiss button, voice control, a fingerprint, or face recognition, through a client device equipped on a terminal. The terminal (where the terminal includes the first interaction terminal and/or the second interaction terminals) may cancel a warning in response to the operation.

In some embodiments, if there is no response to warning information for a long time, a warning may be upgraded to remind a user by changing into an obvious warning feedback manner, so that the user can deal with it in time.

The first interaction terminal and/or the second interaction terminals are configured to: in response to that the clearing operation for the warning information is not received within a preset duration, upgrade the warning level corresponding to the warning information, and send a notification to the first server and/or the second server, so that the first server sends the notification to the first interaction terminal, and/or the second server sends the notification to the second interaction terminals.

The preset duration may be set based on a service requirement. If a duration for which the warning information waits to be processed reaches the preset duration, it may be considered that the warning has not been dealt with in a long time. In some embodiments, warning information of different warning levels may correspond to different preset durations, so that a preset duration can be set flexibly based on importance of warning information to adapt to warnings of different levels.

In some embodiments, the notification may be sent by using an SMS message, an email, notification information, or the like, so that a reminder can be given in a more obvious manner.

In some embodiments, a manner for transferring the notification may be set flexibly based on a service requirement. For example, if there is no response to a warning for a long time, a site manager needs to be notified. In this case, if any warning that needs to be upgraded is found, a notification may be sent, by using the second server, to a second interaction terminal held by the site manager. In another example, if there is no response to warning information for a long time, summarizing and recording need to be performed. In this case, if any warning that needs to be upgraded is found, upgraded warning information may be sent to the first server for summarizing and storage.

In some embodiments, after warning information is upgraded, an authority of cancel operation may be limited, and only a preset user is allowed to cancel a warning. The first interaction terminal and/or the second interaction terminals are configured to: in response to upgrading the warning level of the warning information, clear the warning information in a case that a clearing operation of the second user for the warning information is received.

The second user may be set flexibly based on a service requirement. For example, the second user may be a site manager or a game management personnel.

After the warning information is upgraded, it indicates that importance of the warning information is increased. The terminal clears and transfers the warning information only when the second user logs in to the account of the second user by using the client device to clear the warning information. In this way, it can be ensured that the upgraded warning information is not cleared casually.

Embodiments are described below by using a card game scenario.

A card gaming site includes a plurality of game tables, and each of the game tables is equipped with a game master. The gaming site includes a plurality of site managers, and each of the site manager manages several game tables. In a card game, the game master needs to deal cards to participants in a specified order. If a rule is violated, a warning needs to be issued.

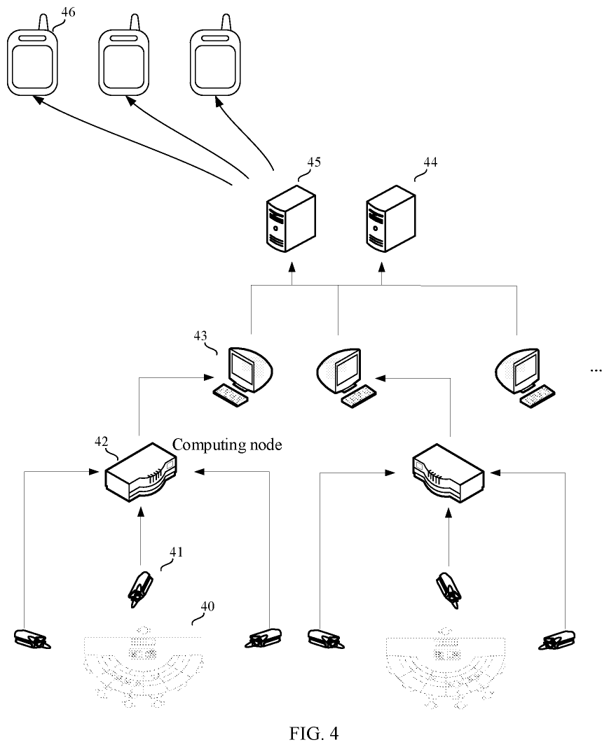

FIG. 4 is a schematic structural diagram of a warning system according to this application.

In FIG. 4, video cameras 41 are respectively deployed directly above each game table 40, on the upper left of each game table 40, and on the upper right of each game table 40, to capture images of the table. The video cameras 41 corresponding to each game table are connected, by a gigabit network port, to a computing node 42 deployed for each game table. A first terminal 43 (that is, the foregoing first interaction terminal) is deployed on the side, on which a game master stands, of each game table, to interact with the game controller. The terminal 43 is equipped with a game client device to control on and off of a game. The computing node 42 is connected to the terminal 43 by a gigabit network port. The warning system further includes a first server 44 providing a service for the terminal 43. The first server may store warning information and the like. The terminal 43 is further connected to a second server 45. The second server 45 is configured to provide a service for a second terminal 46. The second terminal 46 is configured to interact with a site manager. The terminal 43 and the terminal 46 each further include indicator lights of four colors: blue, red, white, and yellow, to prompt warning information of different levels.

The computing node corresponding to each game table in the warning system may implement edge computing, thereby reducing excessive reliance on high bandwidth and a central node, and improving the computing efficiency while improving reliability of the system.

The computing node 42 may maintain a warning condition of an abnormal card dealing order in advance. If the node determines through analysis, based on a live image returned by the video camera 41, that a card dealing order of the game master of the game table 40 is abnormal, the node 42 may generate warning information, and send the warning information to the first terminal 43.

The first terminal 43 may determine a warning level of the warning information based on the abnormal card dealing order. If the card dealing order is level 1, the terminal 43 may turn on the blue indicator light corresponding to level 1, so that the game master can learn of the warning in time, and deal with the warning by such as re-dealing cards or restarting the game.

The terminal 43 may further send the warning information to the first server 44 and the second server 45. The first server 44 may summarize and store the warning information for subsequent review.

The second server 45 may send the warning information to the second terminal 46 held by the site manager managing the game table 40. The terminal 46 may turn on the blue indicator light based on the warning level (level 1), so that the corresponding site manager can learn of the warning in time, and deal with it.

In this example, if the computing node 42 determines through analysis that the card dealing order is back to normal or the game master initiates a warning cancelling request, the computing node may transfer a warning cancelling message based on a warning message transfer path to cancel the warning.

In this example, if the first terminal 43 detects that the game master has not responded to the warning beyond a preset duration, the first terminal may upgrade the warning, and transfer upgraded information through a warning information transfer path to upgrade the warning, so that the site manager can learn of a warning situation in time, and deal with it. In this case, the upgraded warning information can be cleared only by the site manager managing the game table 40, thereby ensuring that the site manager learns of the warning.

In this example, the computing node and a node server corresponding to the computing node may further detect working statuses of the video camera, the computing node, the first terminal, and the second terminal. If an abnormality occurs, a warning may be issued.

In this example, the game master may further initiate an authorization request by using the first terminal. The first terminal may generate warning information based on the authorization request, and transfer the warning information to the second terminal held by the site manager. The site manager may complete or reject authorization by using the second terminal.

In this way, a game process can be automatically monitored and an abnormal situation can be warned of in time by using the warning system, so that a user can learn of a warning in time and deal with it.

This application further provides a warning method. The method may be applicable to a computing node. In the method, a live image is detected, and warning information is reported to a user in response to that a detection result matches a first preset warning condition. In this way, a game process is automatically monitored, and a timely warning of an abnormal situation issued.

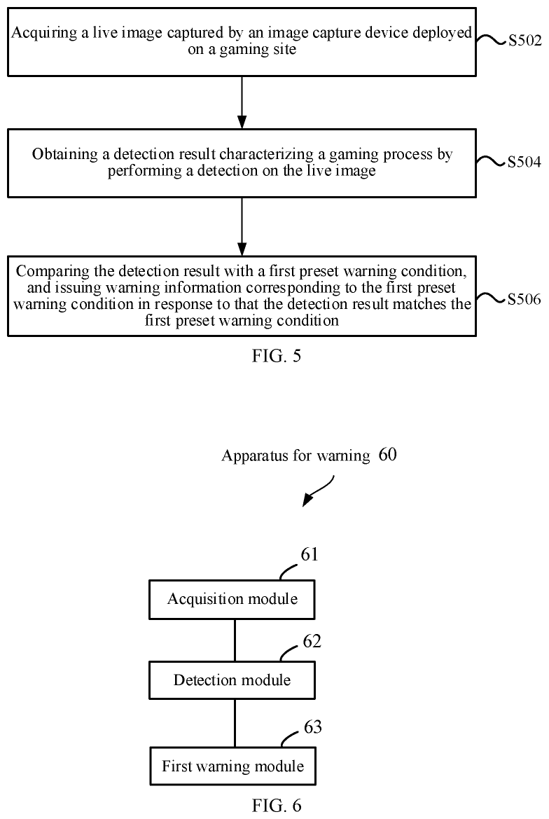

FIG. 5 is a method flowchart of a warning method according to this application.

As shown in FIG. 5, the method may include the following steps:

At S502, acquiring a live image captured by an image capture device deployed on a gaming site.

At S504, obtaining a detection result characterizing a gaming process by performing a detection on the live image.

At S506, comparing the detection result with a first preset warning condition, and issuing warning information corresponding to the first preset warning condition in response to that the detection result matches the first preset warning condition.

The first preset warning condition and a game process detection logic may be set in a computing node in advance. The first preset warning condition may be set based on a service requirement.

The computing node may perform a detection, by using the gaming process detection logic shown in the foregoing embodiment, on the live image to obtain the detection result characterizing the gaming process. If the detection result matches the first preset warning condition, it may indicate that the detection result is abnormal, warning information is generated, reported, and transferred, so that a user can learn of an abnormal situation in time, and deal with it.

In some embodiments, the computing node may send the first warning information to the first interaction terminal in response to that the obtained detection result matches the first preset warning condition.

The first interaction terminal is configured to report the first warning information to the first user in response to a receipt of the first warning information.

In some embodiments, the computing node may detect a working status of the image capture device, report third warning information in response to detecting that the working status of the image capture device matches a second preset warning condition.

In some embodiments, the computing node may further perform the steps shown in the foregoing embodiments to issue a game warning.

Corresponding to any one of the foregoing embodiments, this application further provides a warning apparatus. The apparatus may be applicable to a computing node. The computing node includes a first preset warning condition.

FIG. 6 is a schematic structural diagram of a warning apparatus according to this application.

As shown in FIG. 6, the apparatus 60 may include:

an acquisition module 61, configured to acquire a live image captured by an image capture device deployed on a gaming site;

a detection module 62, configured to obtain a detection result characterizing a gaming process by performing a detection on the live image; and

a first warning module 63, configured to: compare the detection result with a first preset warning condition, and issue warning information corresponding to the first preset warning condition in response to that the detection result matches the first preset warning condition.

In some embodiments, the apparatus 60 further includes a sending module, configured to send first warning information to a first interaction terminal in response to that the obtained detection result matches the first preset warning condition.

The first interaction terminal is configured to report the first warning information to a first user in response to a receipt of the first warning information.

In some embodiments, the apparatus 60 further includes a second warning module, configured to: detect a working status of the image capture device, and report third warning information in response to that the working status of the image capture device matches a second preset warning condition.

This application provides a computer-readable storage medium. The storage medium stores a computer program. The computer program may be configured to cause a processor to perform the warning method according to any one of the foregoing embodiments.

A person skilled in the art should understand that one or more embodiments of this application may be provided as a method, a system, or a computer program product. Therefore, the one or more embodiments of this application may use a form of hardware only embodiments, software only embodiments, or embodiments with a combination of software and hardware. Moreover, one or more embodiments of this application may use a form of a computer program product that is implemented on one or more computer-usable storage media (including but not limited to a disk memory, a CD-ROM, an optical memory, and the like) that include computer-usable program code.

In this application, “and/or” represents at least one of two. For example, “A and/or B” may include three schemes: A, B, and “A and B”.

The embodiments of this application are all described in a progressive manner, for same or similar parts in the embodiments, refer to such embodiments, and descriptions of each embodiment focus on a difference from other embodiments. Especially, a data processing device embodiment is basically similar to a method embodiment, and therefore is described briefly; for related parts, reference may be made to partial descriptions in the method embodiment.

The foregoing describes specific embodiments of this application. Other embodiments fall within the scope of the appended claims. In some cases, the actions or steps recorded in the claims may be performed in sequences different from those in the embodiments and an expected result may still be achieved. In addition, the processes depicted in the accompanying drawings is not necessarily performed in the specific order or successively to achieve an expected result. In some implementations, multitasking and parallel processing may be feasible or beneficial.

The embodiments of the subject and functional operations described in this application may be implemented in the following: a digital electronic circuit, tangible computer software or firmware, computer hardware that can include the structures disclosed in this application and structural equivalents thereof, or a combination of one or more of them. The embodiments of the subject described in this application may be implemented as one or more computer programs, that is, one or one modules in computer program instructions encoded on a tangible non-transitory program carrier to be executed by a data processing apparatus or to control an operation of a data processing apparatus. Alternatively or additionally, program instructions may be encoded on an artificially generated propagation signal, such as an electrical, optical, or electromagnetic signal generated by a machine. The signal is generated to encode information and transmit the information to a proper receiver apparatus, so that a data processing apparatus performs execution. A computer storage medium may be a machine-readable storage device, a machine-readable storage substrate, a random or serial access memory device, or a combination of one or more of them.

The processing and logic procedures described in this application may be executed by one or more programmable computers executing one or more computer programs, to perform an operation based on input data and generate an output to perform a corresponding function. The processing and logic procedures may alternatively be executed by a dedicated logic circuit, such as a field programmable gate array (FPGA) or an application-specific integrated circuit (ASIC), and an apparatus may be implemented as a dedicated logic circuit.

A computer suitable for executing a computer program may include, for example, a general-purpose and/or special-purpose microprocessor, or a central processing unit of any other type. Usually, the central processing unit is to receive instructions and data from a read-only memory and/or a random access memory. Basic components of a computer may include a central processing unit that may be configured to implement or execute instructions and one or more memory devices that may be configured to store instructions and data. Usually, the computer may further include one or more mass storage devices that may be configured to store data, such as magnetic disks, magneto-optical disks, or compact discs, or the computer is to be operatively coupled to the one or more mass storage devices to receive data from the one or more mass storage devices and/or send data to the one or more mass storage devices. However, the computer does not necessarily have such devices. In addition, the computer may be embedded in another device, such as a mobile phone, a personal digital assistant (PDA), a mobile audio or video player, a game console, a global positioning system (GPS) receiver, or a portable storage device such as a universal serial bus (USB) flash drive. There are merely some examples.

Computer-readable media suitable for storing computer program instructions and data may include all forms of non-volatile memories, media, and memory devices, for example, may include semiconductor memory devices (such as an EPROM, an EEPROM, and a flash memory device), magnetic disks (such as an internal hard disk and a removable disk), magneto-optical disks, CD ROMs, and DVD-ROM disks. A processor and a memory may be supplemented by or incorporated into a dedicated logic circuit.

Although this application contains many specific implementation details, these should not be construed as limiting any disclosed scope or the protection scope, and may mainly be used to describe the features of specific disclosed embodiments. Some features described in a plurality of embodiments of this application may alternatively be implemented in combination in a single embodiment. In addition, various features described in a single embodiment may alternatively be separately implemented in a plurality of embodiments or in any suitable sub-combination. In addition, although features may function in some combinations as described and are even initially claimed as such, one or more features from a claimed combination may be removed from the combination in some cases, and the claimed combination may be a sub-combination or a variant of a sub-combination.

Similarly, although the operations are described in a specific order in the accompanying drawings, this should not be understood as requiring such operations to be performed in the shown specific order or in a sequential order, or requiring all illustrated operations to be performed to achieve a desired result. Under some circumstances, multitasking and parallel processing may be advantageous. In addition, separation of various system modules and components in the described embodiments should not be understood as requiring such separation in all embodiments, and it should be understood that the described program components and systems can usually be integrated together into a single software product, or packaged into a plurality of software products.

As such, specific embodiments of the subject have been described. Other embodiments fall within the scope of the appended claims. In some cases, the actions recorded in the claims may be performed in a different order, and the expected result can be achieved. In addition, the processes described in the accompanying drawings do not necessarily require the specific shown order or the sequential order to achieve the desired results. In some implementations, multitasking and parallel processing may be advantageous.

The foregoing descriptions are merely preferred embodiments of one or more embodiments of this application, but are not intended to limit the one or more embodiments of this application. Any modification, equivalent replacement, or improvement made within the spirit and principle of one or more embodiments of this application shall fall within the protection scope of the one or more embodiments of this application.

1. A system of warning, comprising:
an image capture device deployed on a gaming site and configured to capture a live image of a game table on the gaming site; and
a computing node deployed on the gaming site and being connected to the image capture device, wherein the computing node is configured to:
obtain, in response to a receipt of the live image sent by the image capture device, a detection result characterizing a gaming process by performing a detection on the live image; and
report, in response to that the obtained detection result matches a first preset warning condition, first warning information corresponding to the first preset warning condition.

2. The system according to claim 1, further comprises a first interaction terminal connected to the computing node, wherein
the first interaction terminal is configured to interact with a first user controlling the gaming process on the game table;
the computing node is configured to send the first warning information to the first interaction terminal in response to that the obtained detection result matches the first preset warning condition; and
the first interaction terminal is configured to report the first warning information to the first user in response to a receipt of the first warning information.

3. The system according to claim 2, further comprises a first server and a second server that are connected to the first interaction terminal, and a second interaction terminal connected to the second server, wherein
the second interaction terminal is configured to interact with a second user managing one or more game tables on the gaming site;
the first interaction terminal is configured to send the first warning information to the first server and the second server;
the first server is configured to store the first warning information in response to a receipt of the first warning information;
the second server is configured to send the first warning information to the second interaction terminal in response to a receipt of the first warning information; and
the second interaction terminal is configured to report the first warning information to the second user.

4. The system according to claim 3, wherein
a plurality of the second interaction terminals and a plurality of the game tables are provided in the gaming site,
each of the game tables is provided with a group of the image capture devices, the computing node, and the first interaction terminal.

5. The system according to claim 3, wherein the first interaction terminal is configured to:
detect a user operation of the first user, and
report second warning information in response to detecting that the operation of the first user is abnormal or to request authorization.

6. The system according to claim 3, wherein the computing node is configured to:
detect a working status of the image capture device, and
report third warning information in response to detecting that the working status of the image capture device matches a second preset warning condition.

7. The system according to claim 6, further comprises a third server connected to the computing node and configured to:
acquire at least one of a working status and an event of the image capture device and the computing node by using a federation mechanism, and
report fourth warning information in response to that at least one of the working status and the event of the image capture device and the computing node matches the second preset warning condition.

8. The system according to claim 7, wherein
the third server is configured to:
in response to that at least one of the working status and the event of the image capture device or the computing node matches the second preset warning condition, send a warning email by an email system, and
send the fourth warning information to the second server which is connected to the third server;
the second server is configured to:
send the fourth warning information to the second interaction terminal connected to the second server.

9. The system according to claim 3 wherein
for each piece of warning information comprising the first warning information, the second warning information, the third warning information, and the fourth warning information, the system maintains a preset warning condition matching the warning information and a warning level corresponding to the preset warning condition; and
at least one of the first interaction terminal and the second interaction terminal is configured to:
determine a warning level of warning information based on the preset warning condition matching the warning information, and
report the warning information in a feedback manner corresponding to the determined warning level.

10. The system according to claim 9, wherein
at least one of the first interaction terminal and the second interaction terminal comprises a color indicator light corresponding to the warning level; and
at least one of the first interaction terminal and the second interaction terminal is configured to issue the warning information by the color indicator light corresponding to the warning level.

11. The system according to claim 9, wherein at least one of the first interaction terminal and the second interaction terminal is configured to:
clear the warning information in response to a clearing operation for the warning information; and
in response to that the clearing operation for the warning information is not received within a preset duration,
upgrade the warning level corresponding to the warning information, and
send a notification to at least one of the first server and the second server, so to cause at least one of that the first server sends the notification to the first interaction terminal and the second server sends the notification to the second interaction terminal.

12. The system according to claim 11, wherein at least one of the first interaction terminal and the second interaction terminal is configured to:
clear the warning information in response to that a clearing operation for the warning information with upgraded warning level is received.

13. The system according to claim 1, wherein the computing node is further configured to:
in response to determining that a warning event of the game table has been canceled according to the detection result after sending the first warning information, issue information of cancelling warning.

14. A method of warning, applicable to a computing node, the method comprising:
acquiring a live image captured by an image capture device deployed on a gaming site;
obtaining a detection result characterizing a gaming process by performing a detection on the live image; and
comparing the detection result with a first preset warning condition, and
issuing warning information corresponding to the first preset warning condition in response to that the detection result matches the first preset warning condition.

15. A computer-readable storage medium, storing a computer program, wherein the computer program is configured to cause a processor to perform operations for warning, the operations comprising:
acquiring a live image captured by an image capture device deployed on a gaming site;
obtaining a detection result characterizing a gaming process by performing a detection on the live image; and
comparing the detection result with a first preset warning condition, and
issuing warning information corresponding to the first preset warning condition in response to that the detection result matches the first preset warning condition.
